(19) United States
(12) Patent Application Publication
(10) Pub. No.: US 2007/0182048 A1
(43) Pub. Date: Aug. 9, 2007

(54) Molding method and apparatus of fiber filler reinforced resin molded article

(75) Inventors: Junichi Ogawa, (US); Mitsuharu Kaneko, (US); Youhei Ichihara, (US); Takahiro Tochioka, (US)

Correspondence Address: NIXON PEABODY, LLP, 401 9TH STREET, NW, SUITE 900, WASHINGTON, DC, 20004-2128, US

(73) Assignee: MAZDA MOTOR CORPORATION

(21) Appl. No.: 11/636,648

(22) Filed: Dec. 11, 2006

(30) Foreign Application Priority Data
Feb. 2, 2006 (JP) 2006-026305

(51) Int. Cl. B29C 44/12

(52) U.S. Cl. 264/45.3; 264/71; 264/45.9; 425/4 C; 425/200

(57) ABSTRACT

There are provided a plasticizing-kneading step of plasticizing a reinforcement fiber and a resin in a cylinder having a screw, and a metering-injecting step of supplying a physical foaming agent to the resin and injecting them into a cavity of a mold, after metering the necessary amount of resin for molding, a foaming-agent supplying step of supplying the physical foaming agent to the resin passed through a nozzle after being plasticized, and a mixing-dispersion promoting step of promoting mixing and dispersion of the physical foaming agent in the resin in a resin flow path from a supply portion of the physical foaming agent to the cavity of the mold. Accordingly, any breakage of reinforcement fiber is prevented and the mixing and dispersion of the physical foaming agent is improved.

### BACKGROUND OT THE INVENTION

The present invention relates to a molding method and apparatus of a fiber filler reinforced foam resin molded article.

A resin molded article that is made from a foam resin material has been recently used widely for the purpose of weight reduction and the like. A molding method of such a foam resin molded article is generally known, in which a super critical fluid (SCF) as a physical foaming agent is previously supplied to a thermoplastic resin, and then the resin is injected into a cavity (a space in a mold) for foaming with a pressure reducing.

Herein, in order to purse further weight reduction, a resin molded article that is reinforced with a fiber such as a glass fiber to increase strength and rigidity has been also developed. In a molding method of such a fiber filler reinforced foam resin molded article, the resin containing the reinforcement fiber is plasticized and kneaded (molten) in the cylinder of the injection unit by using a screw (a process before injecting into the mold), so that the reinforcement fiber can be mixed properly in the resin. Then, the super critical fluid is supplied to the molten resin with pressing and maintaining a certain pressure, which is followed by injecting the resin into the cavity for the foaming with the pressure reducing. For example, Japanese Patent Laid-Open Publication No. 2005-144750 discloses a molding method which comprises the steps of a) plasticizing/melting a thermoplastic resin and dissolving gas in the molten resin, b) injecting the molten resin into a cavity of a mold after metering, c) preventing foaming of gas by pressurizing the molten resin in the cavity and redissolving the gas in the molten resin, and d) foaming the gas with a volumetric reduction accompanied by cooling/solidification of the resin.

In a case where a fiber filler reinforced foam resin molded article is made with the conventional molding method disclosed in the above-described publication, there is a problem in that at a stage of plasticizing by agitating and kneading the reinforcement fiber and resin, the reinforcement fiber is cut and broken by the screw, so the resin molded article made may have poor properties that is worse than desired ones. In particular, when supplying the physical foaming agent, which is made of the super critical fluid or the like, into the cylinder for plasticizing, there may be the following problem.

Namely, in case of using the super critical fluid as the foaming agent, the super critical fluid is supplied into the molten resin in a pressurized state to prevent foaming, the pressure is maintained in the process of injecting the molten resin into the mold, and then the pressure is finally is reduced (released) in the cavity. Accordingly, the pressure applied to the molten resin in the cylinder is maintained to a high pressure before the injection. In the process of the spiral-shaped screw transmitting the molten resin in a downstream direction (injection end), the above-described pressure also acts on the upstream side of the supply portion of the super critical fluid, therefore a force operative to push back the molten resin, resin pellets, and reinforcement fiber is generated. Accordingly, there may be a necessity that the screw has a certain mechanism to prevent the counterflow of the molten resin containing the super critical fluid at a portion that is upstream of the supply portion of the super critical fluid.

This kind of anti counterflow mechanism generally comprises a labyrinth structure of resin flow path so as to prevent the upstream-direction pushing back. Herein, in case of applying the above-described structure of anti counterflow mechanism to the screw, there is a problem that the reinforcement fiber mixed with the resin is cut into pieces and broken when getting though this mechanism (labyrinth structure). Thus, the properties of the fiber filler reinforced foam resin molded article that is made by the molding method with the super critical fluid would deteriorate improperly.

### SUMMARY OF THE INVENTION

The present invention has been devised in view of the above-described problems, and an object of the present invention is to provide a molding method and apparatus of a fiber filler reinforced resin molded article that can prevent the reinforcement fiber from being broken by not providing any anti counterflow mechanism at the screw and improve properties, such as strength, rigidity and the like, by improving mixing and dispersion of the physical foaming agent in the plasticized resin.

According to the present invention, there is provided a molding method of a fiber filler reinforced resin molded article, which includes a plasticizing-kneading step of plasticizing and kneading a reinforcement fiber and a resin in a material supply cylinder having a screw, and a metering-injecting step of supplying a physical foaming agent to the resin plasticized in the plasticizing-kneading step and injecting the resin into a cavity of a mold, after metering a necessary amount of the resin for molding, the molding method comprising a foaming-agent supplying step of supplying the physical foaming agent to the resin that has passed through at least one nozzle or valve after being plasticized in the plasticizing-kneading step, and a mixing-dispersion promoting step of promoting a mixing and dispersion of the physical foaming agent in the resin in a resin flow path from a supply portion of the physical foaming agent to the cavity of the mold.

Also, according to the present invention, there is provided a molding apparatus of a fiber filler reinforced resin molded article, which includes a mold having a cavity that a resin is injected therein, a plasticizing-kneading portion operative to plasticize and knead a reinforcement fiber and the resin in a material supply cylinder having a screw, and a metering-injecting portion operative to supply a physical foaming agent to the resin plasticized in the plasticizing-kneading portion and inject the resin into the cavity of the mold, after metering a necessary amount of the resin for molding, the molding apparatus comprising a foaming-agent supplying portion operative to supply the physical foaming agent to the resin that has passed through at least one nozzle or valve after being plasticized in the plasticizing-kneading portion, and a mixing-dispersion promoting portion operative to promote a mixing and dispersion of the physical foaming agent in the resin in a resin flow path from a supply portion of the physical foaming agent to the cavity of the mold.

According to the above-described present invention, after the reinforcement fiber and the resin are plasticized and kneaded in the material supply cylinder with the screw, the physical foaming agent is supplied to this resin. Namely, the molten resin with which the reinforcement fiber has been mixed is transmitted to a different portion, where the physical foaming agent is supplied to the resin. Thus, a supply portion of the physical foaming agent (foaming-agent supply portion) is separate from the portion where the reinforcement fiber and the resin are plasticized and kneaded, so a high pressure that may be caused by the supply of the physical foaming agent can be prevented from influence on the portion where the reinforcement fiber and the resin are plasticized and kneaded. Accordingly, it is unnecessary to provide any anti counterflow mechanism at the screw like the conventional way, so the breakage of the reinforcement fiber can be prevented.

Also, the supply of the physical foaming agent is done after the molten resin has passed through at least one nozzle or valve. Herein, the nozzle or valve open or close with an on-off operation, and they allow the resin flow with opening or prevent the resin flow with closing. Thus, by disposing at least one nozzle or valve at a proper portion upstream of the foaming-agent supply portion, the counterflow of the resin can be prevented. Further these nozzle or valve may not cause any breakage of the reinforcement fiber.

Furthermore, the mixing and dispersion of the physical foaming agent in the resin is promoted in the resin flow path from the supply portion of the physical foaming agent to the cavity of the mold. Herein, in a case where the supply portion of the physical foaming agent is separate from the portion where the reinforcement fiber and the resin are plasticized and kneaded, as described above, there is a concern that the mixing and dispersion of the physical foaming agent in the resin may get worse, compared to the conventional way. According to the present invention, however, there is provided the portion for promoting the mixing and dispersion of the physical foaming agent downstream of the foaming-agent supply portion (in the resin flow path from the supply portion of the physical foaming agent to the cavity of the mold), which can improve the mixing and dispersion properly.

As described above, according to the present invention, since it may unnecessary to provide any counterflow mechanism at the screw, the breakage of the reinforcement fiber by the counterflow mechanism can be prevented. Also, since there is provided the portion for promoting the mixing and dispersion, the mixing and dispersion of the physical foaming agent can be ensured or improved.

In the present invention, the physical foaming agent includes any foaming agent with a pressure lower than the super critical pressure, other than the super critical fluid in the super critical state, just excluding a chemical foaming agent that foams with a heat caused by a chemical reaction. Also, promoting of the mixing and dispersion in the resin flow path from the supply portion of the physical foaming agent to the cavity of the mold includes the one caused by agitation and mixing that occurs in the mold.

According to an embodiment of the molding method of the present invention, the mixing-dispersion promoting step is a step of agitation by utilizing a flow of the resin.

Also, according to another embodiment of the molding apparatus of the present invention, the mixing-dispersion promoting portion is a portion to provide an agitation that utilizes a flow of the resin.

According to the above-described embodiments, since the promotion of the mixing and dispersion is provided with the agitation by utilizing the flow of the resin that occurs downstream of the supply portion of the physical foaming agent, the mixing and dispersion of the physical foaming agent in the resin can be promoted efficiently with the agitation effect.

According to another embodiment of the molding method of the present invention, the agitation utilizing the flow of the resin is caused by a supply of the physical foaming agent in the resin in the metering-injecting step.

According to another embodiment of the molding apparatus of the present invention, the agitation utilizing the flow of the resin is caused by a supply of the physical foaming agent in the resin in the metering-injecting portion.

According to the above-described embodiments, since the agitation utilizing the resin flow caused by the supply (confluence) of the physical foaming agent is provided, the proper agitation can be attained in a simple way.

According to another embodiment of the molding method of the present invention, the mixing-dispersion promoting step is a step of adding a vibration to the resin.

According to another embodiment of the molding apparatus of the present invention, the mixing-dispersion promoting portion comprises a device operative to add a vibration to the resin.

According to the above-described embodiments, since the vibration is added to the resin, the mixing and dispersion of the physical foaming agent in the resin can be promoted.

According to another embodiment of the molding method of the present invention, the addition of the vibration is adding a supersonic-wave vibration or an electromagnetic-wave vibration.

According to another embodiment of the molding apparatus of the present invention, the device adding the vibration is a supersonic-wave vibration adding device or an electromagnetic-wave vibration adding device.

According to the above-described embodiments, since the vibration (agitating force) is added to the resin in the cylinder, the mixing and dispersion of the physical foaming agent in the resin can be promoted. Herein, means for adding the vibration is a mechanical-vibration adding device with a supersonic oscillator (vibrator device) or a heating-vibration adding device with electromagnetic waves. In a case of using the supersonic-wave vibration, a supersonic oscillator is attached to a side wall of the cylinder (outer face or inner face) of a second injecting portion, and the supersonic oscillator vibrates by receiving a supersonic voltage from a supersonic vibrator. In case of using the electromagnetic-wave vibration, the same performance is attained.

According to another embodiment of the molding method of the present invention, the mixing-dispersion promoting step is a step of a driven agitation with an agitating member being driven in the resin flow.

According to another embodiment of the molding apparatus of the present invention, the mixing-dispersion promoting portion comprises an agitating member being driven in the resin flow.

According to the above-described embodiments, the agitating member (for example, an agitating plate having plural through holes that is disposed in a space on a side of a junction portion of an injection piston) is disposed in the resin path (for example, in the cylinder at the foaming-agent supply portion), and the agitating member is driven (back and forth) in a state where the position of the injection piston is fixed. This back-and-forth movement of the agitating member can promote the mixing and dispersion of the physical foaming agent in the resin path (in the cylinder).

According to another embodiment of the molding method of the present invention, the mixing-dispersion promoting step is a step that is conducted in the resin flow path in the mold before the resin flowing into the cavity.

According to another embodiment of the molding apparatus of the present invention, the mixing-dispersion promoting portion is provided in the resin flow path in the mold before the resin flowing into the cavity.

According to the above-described embodiments, since the mixing-dispersion promoting step or portion are provided in the resin flow path in the mold before the resin flowing into the cavity, the mixing and dispersion of the physical foaming agent can be promoted in a simple and sure way, without providing any structural restrictions at the mold and any space problems in the device.

According to another embodiment of the molding method of the present invention, the mixing and dispersion of the physical foaming agent is promoted by injecting the plasticized resin with the reinforcement fiber into a dilute resin to which the physical foaming agent has been supplied in the resin flow path in the mold.

According to another embodiment of the molding apparatus of the present invention, the promotion of mixing and dispersion of the physical foaming agent by the mixing-dispersion promoting portion is conducted by injecting the plasticized resin with the reinforcement fiber into a dilute resin to which the physical foaming agent has been supplied in the resin flow path in the mold.

According to the above-described embodiments, since the mixing and dispersion of the physical foaming agent is promoted by injecting the plasticized resin with the reinforcement fiber into the dilute resin to which the physical foaming agent has been supplied in the resin flow path in the mold, the promotion of the mixing and dispersion of the physical foaming agent can be attained in a simple and sure way, without providing any structural restrictions at the mold and any space problems in the device.

Herein, the resin with the reinforcement fiber means the one that contains much content of reinforcement fiber than that of the fiber filler reinforced resin molded article, and by mixing with the dilute resin to which the physical foaming agent has been supplied, it come to have a specified (determined) content of a product (the reinforcement fiber of the fiber filler reinforced resin molded article). Also, the dilute resin means resin for dilution, with which substantially no reinforcement fiber is mixed.

According to another embodiment of the molding method of the present invention, a viscosity of the resin with the reinforcement fiber is substantially equal to a viscosity of the dilute resin to which the physical foaming agent has been supplied.

According to the above-described embodiment, since the difference in the viscosity between the resin with the reinforcement fiber and the dilute resin to which the physical foaming agent has been supplied is small, the breakage of the reinforcement fiber can be suppressed and the smooth mixing of the both can be attained. Namely, if the viscosity of the dilute resin is improperly high, the reinforcement fiber would receive a large stress at the time of mixing, and thereby the risk of breakage of the reinforcement fiber would increase. Accordingly, it is preferable that the dilute resin have a properly low viscosity so that the large stress can be prevented from acting on the reinforcement fiber.

According to another embodiment of the molding method of the present invention, the plasticized resin with the reinforcement fiber is collected in a resin collection portion, and the collected resin is supplied to the mold through the metering-injecting portion.

According to the above-described embodiment, since the plasticized resin with the reinforcement fiber is collected in the resin collection portion once, the collected resin is supplied to the metering-injecting portion, where the physical foaming agent is supplied, and then it is injected into the cavity of the mold through the metering-injecting portion, the mixing and dispersion of the physical foaming agent can be further promoted in a much simpler and sure way.

According to another embodiment of the molding method or apparatus of the present invention, the physical foaming agent is a super critical fluid.

According to the above-described embodiment, the above-described improvement of the mixing and dispersion of the physical foaming agent can be attained properly, so the fiber filler reinforced resin molded article having a properly fine foam cell can be provided and its properties can be further improved.

Other features, aspects, and advantages of the present invention will become apparent from the following description which refers to the accompanying drawings.

### BRIEF DESCRIPTION OF THE DRAWINGS

FIG. 1A is a side view showing an entire structure of a fiber filler reinforced resin injection molding apparatus according to a first embodiment of the present invention,

FIG. 1B is a sectional view showing a cylinder inside of a first injecting portion, and FIG. 1C is a sectional view showing a structure of a major portion of the cylinder inside of a second injecting portion.

FIG. 2 is a sectional view showing a major portion of a mixing nozzle.

FIG. 3 is a side view showing a schematic structure of the fiber filler reinforced resin injection molding apparatus that is equipped with the mixing nozzle (first attaching state) according to the first embodiment.

FIG. 4 is a side view showing a schematic structure of the fiber filler reinforced resin injection molding apparatus that is equipped with the mixing nozzle (second attaching state) according to the first embodiment.

FIG. 5 is a side view showing a schematic structure of the fiber filler reinforced resin injection molding apparatus that is equipped with the mixing nozzle (third attaching state) according to the first embodiment.

FIG. 6 is a sectional view of a mold in which the mixing nozzle and a similar agitating device are provided at a hot runner portion.

FIG. 7 is a side view of a physical foaming-agent supply portion in which a porous member is disposed at an inside wall of a supply nozzle.

FIG. 8A is a sectional view showing a cylinder inside of the second injecting portion with a supersonic oscillator (or an electromagnetic-wave oscillator) of a vibration adding device, and FIG. 8B is a sectional view showing an attachment state of an agitating plate in the cylinder inside of the metering injecting portion.

FIG. 9 is a side view showing a schematic structure of a fiber filler reinforced resin injection molding apparatus according to a second embodiment of the present invention.

FIG. 10 is a side view showing a schematic structure of a fiber filler reinforced resin injection molding apparatus according to a third embodiment of the present invention.

FIG. 11 is a side view showing a schematic structure of a modified fiber filler reinforced resin injection molding apparatus according to the first embodiment, in which a physical-agent supply portion is located at a junction portion.

FIG. 12 is a side view showing a schematic structure of a modified fiber filler reinforced resin injection molding apparatus according to the second embodiment, in which the physical-agent supply portion is located downstream of a resin collection portion.

FIG. 13 is a side view showing a schematic structure of a modified fiber filler reinforced resin injection molding apparatus according to the second embodiment, in which the physical-agent supply portion is located upstream of the resin collection portion.

FIG. 14 is a side view showing a schematic structure of a modified fiber filler reinforced resin injection molding apparatus according to the third embodiment, in which the mixing nozzle is attached downstream of two injecting portions.

### DETAILED DESCRIPTION OF THE INVENTION

Hereinafter, preferred embodiments of a molding method and apparatus of a fiber filler reinforced resin molded article of the present invention will be described specifically.

### Embodiment 1

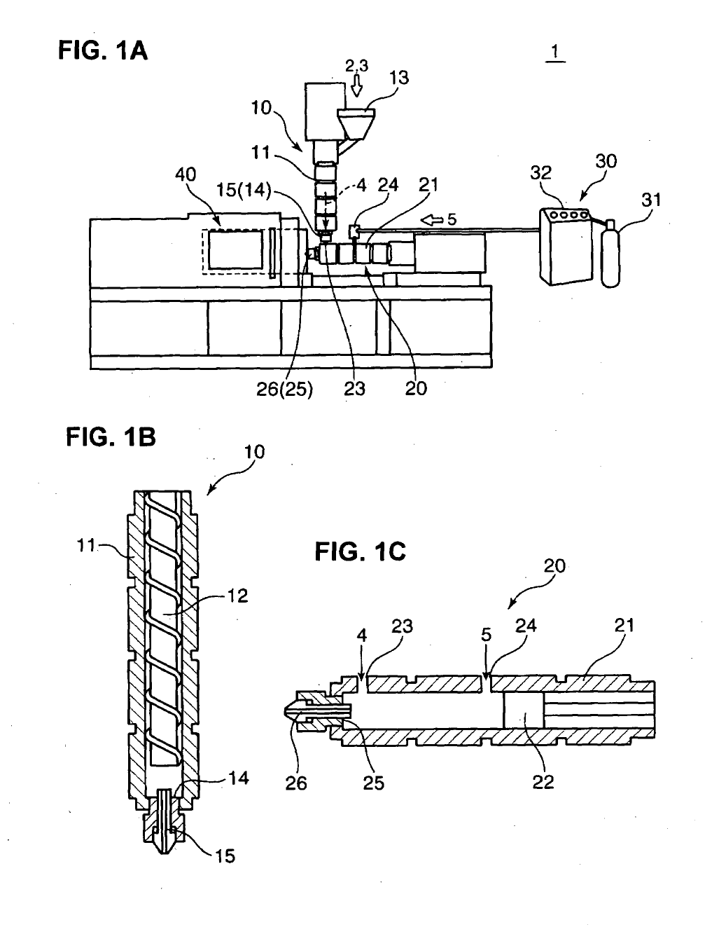

An entire structure of a fiber filler reinforced resin injection molding apparatus according to a first embodiment of the present invention is shown in FIG. 1. The fiber filler reinforced resin injection molding apparatus 1 comprises two injection units of a first injecting portion 10 and a second injecting portion 20, a SCF supply unit 30, and a mold 40.

The first injecting portion 10 (plasticizing and kneading portion) has a screw 12 in a cylinder 11, and kneads a reinforcement fiber 3 and a resin 2 which is provided from a hopper 13 with a rotation of the screw 12 for plasticizing (melting). And, it transmits (injects) a plasticized molten resin 4 containing the reinforcement fiber 3 (hereinafter, referred to as resin composite 4) from an injecting end 14 (downstream outlet) toward a junction portion 23 to a second injecting portion 20, which will be described below. At the injecting end 14 of the first injecting portion 10 is provided a shut-off nozzle 15 that conducts an on-off operation.

The second injecting portion 20 (metering injecting portion) includes an injection piston 32 in a cylinder 21, and guides the resin composite 4 containing the reinforcement fiber 3 to the junction portion 23. Further, after metering of the resin composite 4 for a necessary amount for molding, a physical foaming agent 5 that has been supplied from the SCF supply unit 30 is supplied into the resin composite 4 at a foaming-agent supply portion 24. Then, after mixing and dispersion, the resin composite 4 is injected into a cavity 43 (see FIG. 6) of the mold 40 with a reciprocating movement of the injection piston 22. Herein, supplies of the resin composite 4 and the physical foaming agent 5 from the foaming-agent supply portion 24 at the junction portion 23 are controlled so as to be conducted almost at the same time. Thus, the supply (confluence) of the physical foaming agent 5 to the resin composite 4 at the junction portion functions as a mixing-dispersion promoting portion that promotes mixing and dispersion of the physical foaming agent 5 in the resin composite 4. Accordingly, since an agitating portion (means) is formed by utilizing the flow of resin composite 4 itself, the mixing-dispersion promoting portion can be materialized with a simple way. Thus, the resin composite 4 with the sufficiently mixed physical foaming agent 5 is injected into the cavity 43 of the mold 40. At an injecting end 25. (downstream outlet) of the second injecting portion 20 is provided a shut-off nozzle 26 that conducts an on-off operation as properly.

The SCF supply unit 30 guides the physical foaming agent 5 into the fiber filler reinforced resin injection molding apparatus 1, in which the foaming agent 5 is supplied into the resin composite 4 at a specified supply portion (foaming-agent supply portions 24, 57) provided at the second injecting portion 20 or a mixing nozzle 50 (see FIG. 4) which will be described below. The SCF supply unit 30 comprises a gas reservoir 31 with a raw gas stored therein, and a pressure-increase control portion 32 to increase a pressure of the raw gas from the gas reservoir 31 to a specified pressure and control a supply amount of the pressure-increased physical foaming agent into the cylinder.

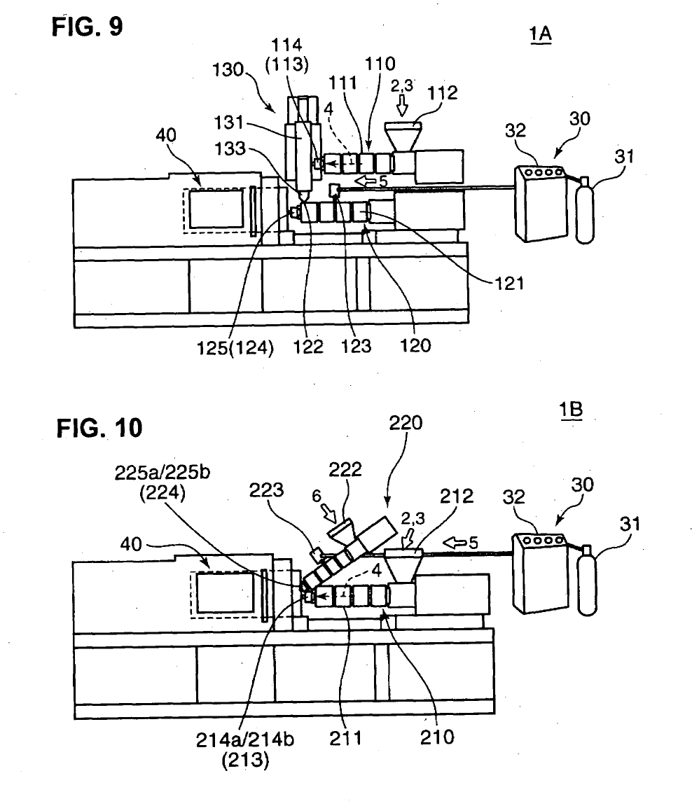

The shut-off nozzles 15, 26 at the injecting ends 14, 25 (downstream outlets) of the first and second injecting portions 10, 20 allow the resin composite 4 flow downstream by releasing an upstream pressure (to a normal pressure in the plasticizing-kneading state), and when closing, ensures sealing in the nozzle (prevents counterflow). Herein, since these nozzles 15, 26 with no labyrinth structure are just operated to open or close and not provided at the screw 12, the reinforcement fiber 3 may not be broken or hurt by operations of the nozzle. Also, any other type of devices, such as valves 114, 133 (see FIG. 9) of the second embodiment, which will be described below, may be applied instead of the above nozzles 15, 26 as long as they can shut the pressure by close/open operation, avoiding any breakage of the reinforcement fiber 3. Herein, either one of nozzles 15 (26) may be used and the other is replaced by one of valves 133 (114).

According to the present embodiment, the resin composite 4, which is formed with the resin 2 and the reinforcement fiber 3 that have been plasticized and kneaded at the first injecting portion 10, is transmitted to the second injecting portion 20, where the physical foaming agent 5 is supplied to this resin (at the foaming-agent supply portion 24). Thereby, the mixing and dispersion of the physical foaming agent 5 in the resin composite 4 is promoted by the supplies of the resin composite 4 and the physical foaming agent 5. Then, after metering of the resin composite 4 for the necessary amount for molding, the resin composite 4 is injected into the mold 40 (cavity 43) from the injecting end 25 of the second injecting portion 20.

Thus, since the supply portion of the physical foaming agent 5 (foaming-agent supply portion 24) is separate from the portion where the reinforcement fiber 3 and the resin 2 are plasticized and kneaded (plasticizing-kneading portion of the first injecting portion 10), a high pressure that may be caused by the supply of the physical foaming agent 5 can be prevented from influencing on the portion where the reinforcement fiber and the resin are plasticized and kneaded. Accordingly, it is unnecessary to provide any anti counterflow mechanism at the screw like the conventional way, so the breakage of the reinforcement fiber 3 can be prevented.

Also, according to the present embodiment, the supply of the physical foaming agent 5 is conducted at the foaming-agent supply portion 24 after the molten resin has passed through at least one nozzle (shut-off nozzle 15). And, there is provided the junction portion 23 to prove the mixing and dispersion of the physical foaming agent 5 in the resin composite 4 containing reinforcement fiber 3 in the resin flow path from the supply portion of the physical foaming agent 5 (foaming-agent supply portion 24) to the cavity 43 of the mold 40.

Herein, in a case where the foaming-agent supply portion 24 is separate from the portion where the reinforcement fiber 3 and the resin 2 are plasticized and kneaded, as described above, there is a concern that the mixing and dispersion of the physical foaming agent 5 in the resin composite 4 may get worse. According to the present embodiment, however, there is provided the portion (unction portion 23) for promoting the mixing and dispersion of the physical foaming agent 5 downstream of the foaming-agent supply portion 24 (in the resin flow path from the supply portion of the physical foaming agent 5 to the cavity 43 of the mold 40), which can improve the mixing and dispersion properly. Namely, since the agitating portion (means) is formed by utilizing the flow of resin composite 4 itself, the mixing-dispersion promoting portion can be materialized with the simple way.

As described above, according to the present invention, since it may unnecessary to provide any counterflow mechanism at the screw 12, the breakage of the reinforcement fiber 3 by the counterflow mechanism can be prevented. Also, since there is provided the portion step or portion for promoting the mixing and dispersion, the mixing and dispersion of the physical foaming agent can be ensured or improved.

In the present embodiment, a thermoplastic resin is used as the following resin 2, and the following thermoplastic resin may be applied; polyethylene-based resin, polypropylene-based resin, acrylonitrile-butadiene-styrene copolymer (ABS resin), polystyrene-based resin, polycarbonate-based resin, polyethylene terephthalate, polybutylene terephthalate, acrylonitrile-styrene copolymer (AS resin), sybdiotactic polystyrene, polymethyl methacrylate, polyphenylene sulfide, polyether sulfone, polyarylate, polyamide, polyimide, liquid crystal resin, polyphenylene oxide, polyacetal, polyethylene naphthalate, and so on. Especially, the polypropylene-based resin, polystyrene-based resin, polycarbonate-based resin, sybdiotactic polystyrene, polyphenylene sulfide are preferable, and polypropylene-based resin are more preferable. Also, polymer blend is applicable as the thermoplastic resin.

Also, as the reinforcement fiber 3, glass fiber, carbon fiber, inorganic whisker, potassium titanate whisker, and so on may be applied.

The content of the thermoplastic resin 2 with respect to the thermoplastic resin composite 4 is preferably 20-95 wt %, more preferably 60-90 wt %. There is a concern of a poor flowing function or a weak mechanical rigidity if the content of the thermoplastic resin 2 is too small. Also, the content of the reinforcement fiber 3 with respect to the thermoplastic resin composite 4 is preferably 0-50 wt %, more preferably 10-40 wt %.

Further, to the above-described thermoplastic resin composite 4 may be added an additive or changing agent, such as powder fillers, plasticizing agent, stabilizing agent, anti oxidant, ultraviolet-ray absorbent, anti-charging agent, flame retarder, or flame-resistant agent.

The physical foaming agent 5 in the present embodiment includes any foaming agent with a pressure lower than the super critical pressure, other than the super critical fluid in the super critical state (Super Critical Fluid: SCF), just excluding a chemical foaming agent that foams with a heat caused by a chemical reaction. Although any type of physical foaming agent 5 may be applied in the present embodiment as long as it can be molten in the thermoplastic resin composite 4 and is an inert gas regardless of being in the super critical state, the super critical fluid of carbon dioxide, nitrogen or composite gas of these is preferable from viewpoints of safety, costs and the like. And, when the physical foaming agent 5 of these gas is applied, the foaming agent 4 can be mixed and dispersed properly, thereby providing the fiber filler reinforced resin molded article (product) having a properly fine foam cell and a further improved properties.

The application of the super critical fluid of carbon dioxide may be more preferable because of little damage against the global environment. The critical temperature of the carbon dioxide is 31.3° C. and the critical pressure thereof is 7.4 MPa, and the critical temperature of the nitrogen is −147° C. and the critical pressure thereof is 3.4 MPa. Accordingly, the super critical state of these can be easily maintained by heating and pressuring (herein, heating may not be necessary for the nitrogen). Also, since the super critical fluid of the carbon dioxide or nitrogen functions as a plasticizing agent, the flowing of the resin can be improved, thereby providing the injection molding of the resin composite 4 containing the reinforcement fiber 3 with better flowing properties.

It is preferable from viewpoints of ensuring a sufficient supply speed that the pressure at a time the physical foaming agent 4 is supplied to the thermoplastic resin composite 4 be set to 15 MPa or more, further preferably 20 MPa or more. The supply amount of the physical foaming agent 5 depends on the kind thereof, but it is preferable that the supply amount with respect to 100 wt % of the thermoplastic resin composite 4 be set to 0.1-20 wt %, further preferably 0.5-10 wt %. When the physical foaming agent 5 is less than 0.1 wt %, the properly fine foam cell can not be provided. Meanwhile, when the physical foaming agent 5 is greater than 20 wt %, the foam cell may become too large and so an appearance of the molded article may deteriorate.

In the present embodiment, the mold 40 comprises a stationary mold 41 and a movable mold 42, which are made from metal material such as carbon steel, aluminum alloy, or copper alloy, as shown in FIG. 6. The cavity 43 is formed by these molds 41, 42 coupled to each other, and a hot runner portion 46 is provided in a flow path of the molten resin composite 5 from an injection supply hole 44 (nozzle) to a gate 45.

Further, the following modified embodiments of the fiber filler reinforced resin injection molding apparatus 1 equipped with some means for promoting the mixing and dispersion of the physical foaming agent 5 may be applied.

1. Mixing-Dispersion Promotion of the Physical Foaming Agent by Utilizing Flowing (Agitation) of the Resin Composite

1) Mixing Promotion Using Mixing Nozzle

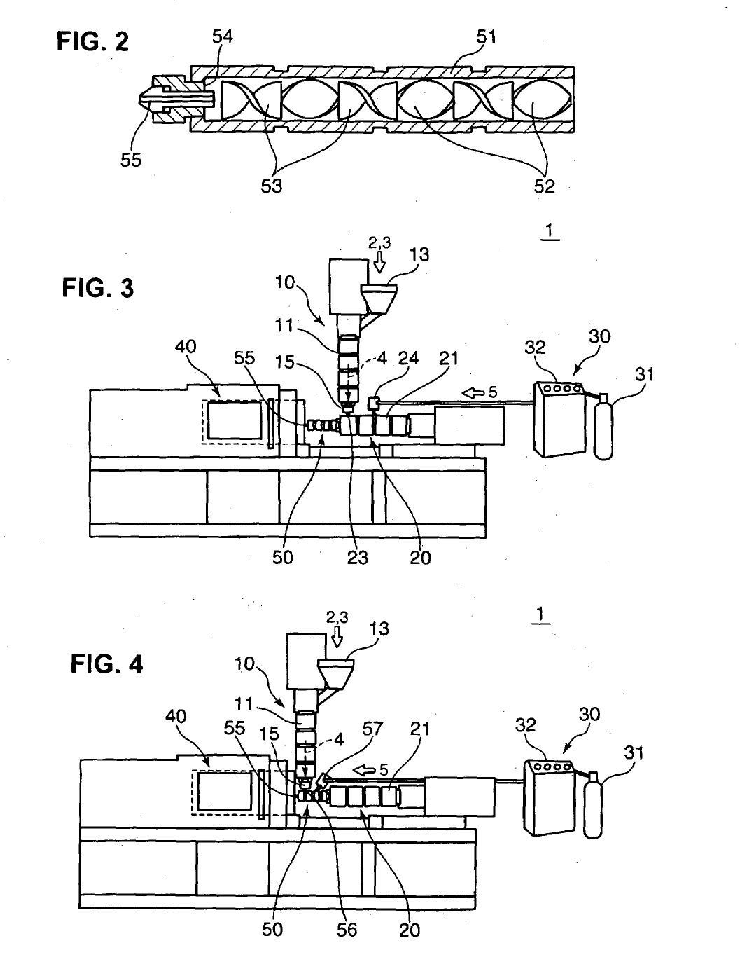

First, the mixing promotion using a mixing nozzle as a means utilizing flowing of the resin composite 4 will be described. A mixing nozzle 50 is configured, as shown in FIG. 2, such that elements A52 that are made of flat plats respectively by twisting clockwise by 180 degrees spirally and other elements B53 that are made of flat plates respectively by twisting counterclockwise by 180 degrees spirally are disposed one after the other in a cylindrical nozzle 51. The resin composite 4 that has been guided in the mixing nozzle 51 is twisted clockwise and counterclockwise repeatedly when proceeding in the nozzle. Thereby, the mixing and dispersion of the reinforcement fiber 3 and the physical foaming agent 5 can be promoted. Herein, the internal structure of the mixing nozzle 50 is not limited to the above-described one, but any modifications may be applied as long as the molten resin (resin composite 4) can be agitated properly in the resin flowing path and thereby the mixing and dispersion of the reinforcement fiber 3 and physical foaming agent 5 can be promoted. And, for example, a shut-off nozzle 55 is provided at a supply outlet 54 of the resin composite 4 agitated in the mixing nozzle 50.

The following three embodiments for attaching the mixing nozzle 50 may be exemplified.

A) In a first attaching embodiment shown in FIG. 3, the junction portion 23 to the first injecting portion 10 is formed on a side of the injecting end 14 of the second injecting portion 20, the mixing nozzle 50 is provided between the downstream an outlet of the junction portion 23 and the injection supply hole 44, and the foaming-agent supply portion 24 is provided upstream of the junction portion 23 of the second injecting portion 20. The resin composite 4 containing the reinforcement fiber 3, which are kneaded at the first injecting portion 10, is supplied to the junction portion 23 to the second injecting portion 20. The physical foaming agent 5 is supplied to the resin composite 4, and after metering of the resin composite 4 for the necessary amount for molding, the resin composite 4 is supplied into the cavity 43 of the mold 40 via the mixing nozzle 50. Herein, as described above, the mixing and dispersion of the physical foaming agent 5 in the resin composite 4 is promoted when the physical foaming agent 5 is supplied and also when the resin composite 4 flows down in the mixing nozzle.

B) In a second attaching embodiment shown in FIG. 4, the mixing nozzle 50 is provided between the injecting end 25 of the second injecting portion 20 and the injection supply hole 44 (see FIG. 6) of the mold 40, a junction portion 56 to the first injecting portion 10 is formed downstream of the mixing nozzle 50, and a foaming-agent supply portion 57 is provided between the supply outlet 54 (injecting end 25 of the second injecting portion 20) of the mixing nozzle 50 on the side of the first injecting portion 10 and the junction portion 56. The resin composite 4 containing the reinforcement fiber 3, which are supplied from the first injecting portion 10, is supplied via the junction portion 56 of the mixing nozzle 50. The resin composite 4 containing the reinforcement fiber 3 is further supplied to the second injecting portion 20, and after metering of the resin composite 4 for the necessary amount for molding at the second injecting portion 20, the resin composite 4 is supplied into the cavity 43 of the mold 40 via the mixing nozzle 50. Herein, when the resin composite 4 is supplied to the second injecting portion 20, the physical foaming agent 5 is supplied from the foaming-agent supply portion 57, and the mixing and dispersion of the physical foaming agent 5 in the resin composite 4 is promoted when flowing down in the mixing nozzle 50.

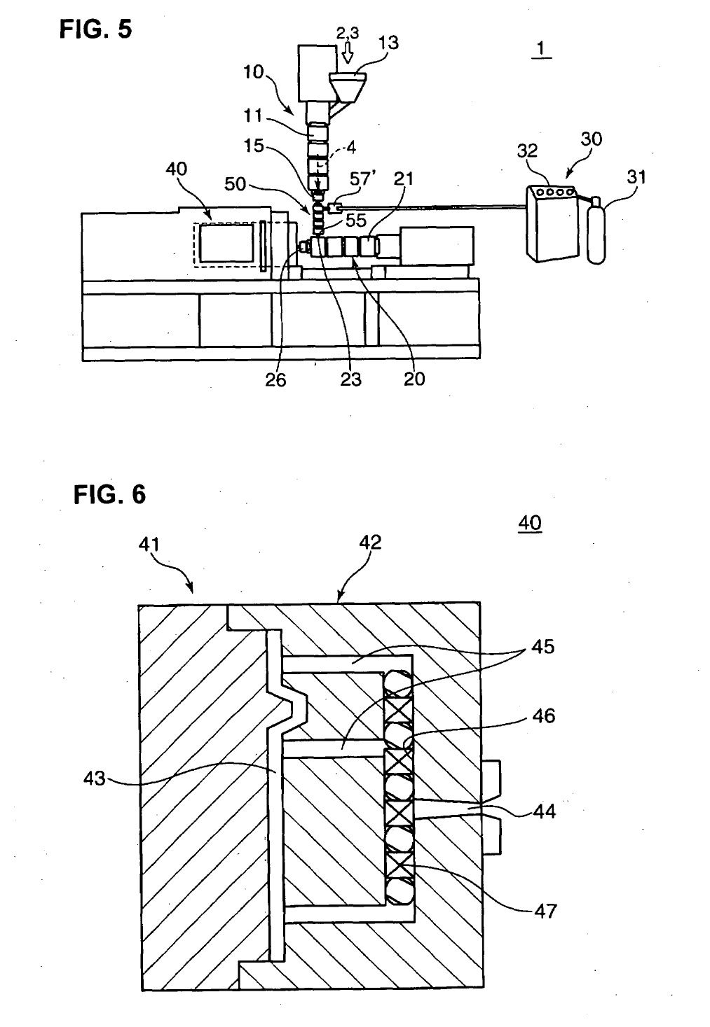

C) In a third attaching embodiment shown in FIG. 5, an upstream end of the mixing nozzle 50 is connected to the injecting end 14 (shut-off nozzle 15) of the first injecting portion 10, a downstream end (supply outlet 54) of the mixing nozzle 50 is connected to the junction portion 23 of the second injecting portion 20, and a foaming-agent supply portion 57′ is provided at a portion just downstream of the upstream end of the mixing nozzle 50. The resin composite 4 containing the reinforcement fiber 3 is supplied to the mixing nozzle 50 from the first injecting portion 10. At the same time, the physical foaming agent 5 is supplied from the foaming-agent supply portion 57′. The resin composite 4 containing the reinforcement fiber 3 is supplied to the second injecting portion 20, and after metering of the resin composite 4 for the necessary amount for molding at the second injecting portion, the resin composite is supplied into the cavity of the mold. Herein, when the resin composite 4 flows down in the mixing nozzle 50 and when the resin composite is supplied to the junction portion 23 of the second injecting portion 20, the mixing and dispersion of the physical foaming agent 5 in the resin composite 4 is promoted.

As described above, the promotion of the mixing and dispersion of the physical foaming agent 5 is materialized by the means (for example, mixing nozzle 50) that has a mixing-dispersion function by utilizing the resin flowing and is provided downstream of the supply portion (foaming-agent supply portions 24, 57, 57′) of the physical foaming agent 5. Thereby, the mixing and dispersion of the physical foaming agent 5 in the resin composite 4 can be efficiently promoted.

2) Mixing Promotion with Mixing Portion Provided at Hot Runner Portion in Mold

A mixing portion 47 that has the kneading-agitating function as the above-described mixing nozzle 50 may be provided in the flow path (e.g., hot runner 46) of the resin composite 4 from the supply inlet hole 44 to the gate 45 in the mold 40 as shown in FIG. 6. Thereby, the mixing and dispersion of the reinforcement fiber 3 and physical foaming agent 4 can be promoted before the resin composite 4 flows into the mold 40 (gate 45). Since the mixing-dispersion promoting means (portion) is provided in the resin flow path in the mold 40, the mixing and dispersion of the physical foaming agent 5 can be promoted in a simple and sure way, without providing any structural restrictions at the mold and any space problems in the device. Herein, in a case where the mixing-dispersion promoting means (portion) such as the mixing nozzle 50 is provided at a portion before (upstream) the mold 40, there may be no needs for any structural change of the mold 40.

2. Mixing-Dispersion Promotion of the Physical Foaming Agent by a Porous Structure at the Foaming-Agent Supply Portion

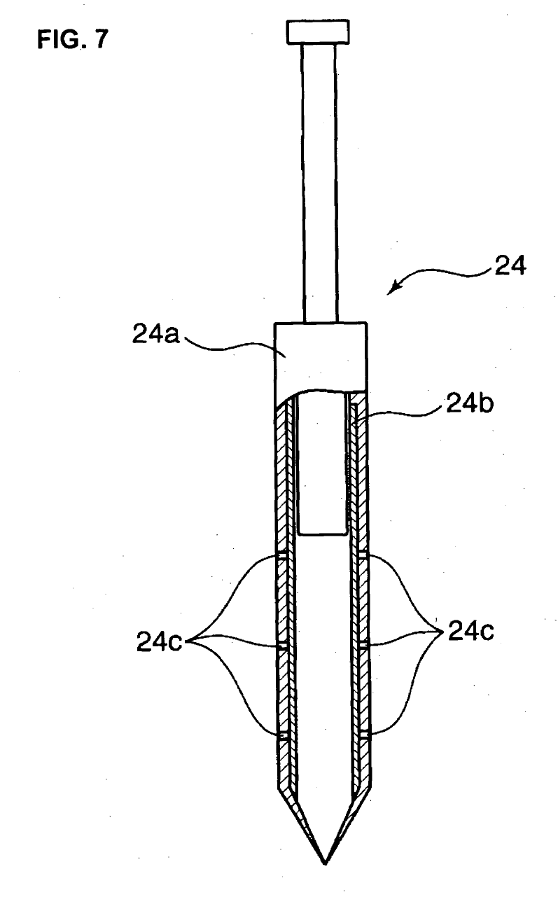

A porous structure 24b (e.g., a metal porous member) may be disposed at an inner wall face of the injection nozzle 24a at the foaming-agent supply portion 24 of the second injecting portion 20 as shown in FIG. 7. Thereby, the physical foaming agent 5 is introduced into the resin composite 4 with an increased contacting face, so a prompt dispersion of the physical foaming agent 5 into the resin composite 4 can be attained (namely, by enhancing dispersibility of the physical foaming agent 5 in the resin composite 4), thereby promoting the mixing and dispersion with a simple and sure way.

3. Mixing-Dispersion Promotion of the Physical Foaming Agent by a Vibration Adding Means (Device) at the Second Injecting Portion

The mixing and dispersion of the physical foaming agent 5 may be preferably promoted by a vibration adding means (for example, supersonic-wave vibration adding device, electromagnetic-wave vibrator, or driven agitating mechanism) provided at the second injecting portion 20.

1) Supersonic-Wave Vibration Adding Device or Electromagnetic-Wave Vibrator

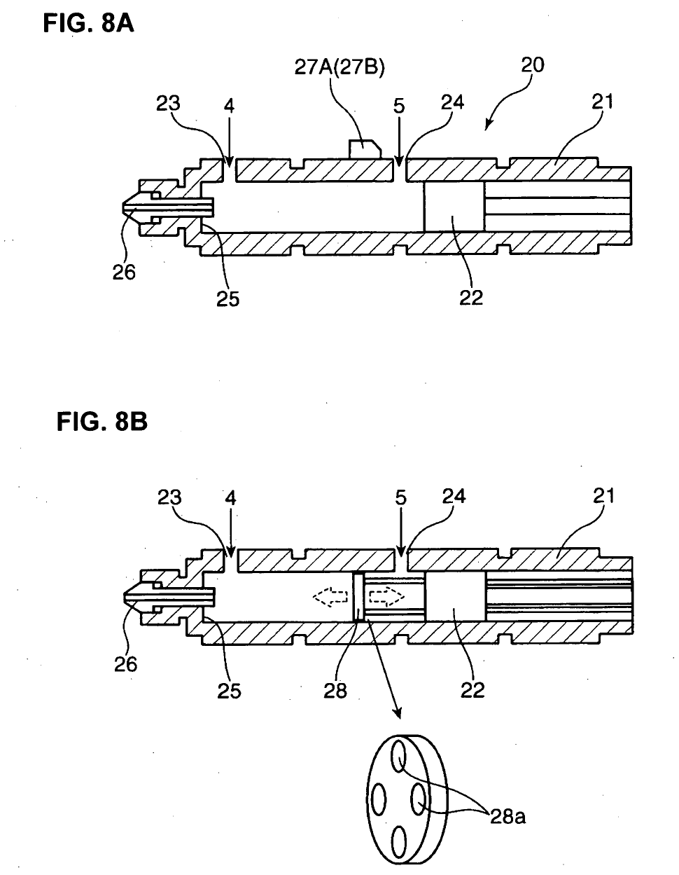

For example, a mechanical-vibration adding device with a supersonic oscillator (vibrator device) or a heating-vibration adding device with an electromagnetic-wave vibrator may be applied as the vibration adding device. In a case of using a supersonic vibration, as shown in FIG. 8A, a supersonic oscillator 27A is attached to the side wall of the cylinder 21 (cylinder barrel outer face) of the second injecting portion 20. The supersonic oscillator 27A vibrates by receiving a supersonic voltage from a supersonic vibrator, not illustrated, so the vibration (agitating force) can be added to the resin composite 4 in the cylinder 21. An attaching portion of the supersonic oscillator 27A is not limited to the above-described portion. In a case of using an electromagnetic-wave vibration adding device, an attachment of an electromagnetic-wave vibrator 27B is the same as above.

Thus, the vibration is added to the resin composite 4 with the device such as the supersonic oscillator 27A and electromagnetic-wave vibrator 27B, so the mixing and dispersion of the physical foaming agent 5 in the resin composite 4 can be promoted.

2) Driven Agitating Device

As shown in FIG. 8B, an agitating plate 28 (driven agitating device) having plural through holes 28a is disposed in a space that is located on a side of the junction portion 23 before the injection piston 22 in the cylinder 21 of the second injecting portion 20. This agitating plate 28 is operated so as to move back and force (reciprocate) in a state where the location of the injection piston 22 is fixed. Thereby, the resin composite 4 is made get through these holes 28a according to the back-and-forth movement of the agitating plate 28 (generating a turbulence), so the mixing and dispersion of the physical foaming agent 5 in the resin composite 4 can be promoted. When the injection is conducted, both the injection piston 22 and the agitating plate 28 are moved forward to inject the resin composite 4 into the mold 40.

Herein, when the injection is conducted, the agitating plate 28 is moved forward along with the injection piston 22 in a state where it is fixed to the piston 22, or previously moved forward before the piston 22 is moved forward, so that the agitating plate 28 can be prevented from interfering with the movement of the injection piston 22 at the injection. A shape or the number of the through holes 28a of the agitating plate 36 should not be limited to an illustrated circular shape or four. Also, something like the above-described elements 52, 53 (180-degree clockwise and counterclockwise twisted plates) applied to the mixing nozzle 50 may be provided at the holes 28a, or the holes 28a may be formed to be of a spiral shape like these elements 52, 53. Thereby, the effect of the promotion of mixing and dispersion by the agitating plate 28 can be enhanced.

Further, any type of agitating device other than the above plate 28, which can add the flowing force to the resin composite 4 with a reciprocating drive or a rotating drive and thereby agitate it, may be applied. For example, a propeller type of member with agitating wings may be rotated, or a plate member with circular holes having agitating wings therein may be reciprocated.

### Embodiment 2

An entire structure of a fiber filler reinforced resin injection molding apparatus according to a second embodiment of the present invention is shown in FIG. 9. A fiber filler reinforced resin injection molding apparatus 1A basically comprises a plasticizing pushing portion 110, metering injecting portion 120, resin collection portion 130, SCF supply unit 30 and mold 40.

The plasticizing pushing portion 110 (plasticizing-kneading portion) corresponds to the first injecting portion 10 of the injection molding apparatus 1 of the first embodiment. The resin composite 4 plasticized at the plasticizing pushing portion 110 is supplied to the resin collection portion 130 provided downstream thereof, where the resin is collected temporarily in a collector 131. Thus, the plasticizing pushing portion 110 needs not have an injection function with the screw like the above-described first injecting portion 10, but have a pushing function with the screw. Also, the metering injecting portion 120 corresponds to the second injecting portion 20 of the injection molding apparatus 1 of the first embodiment. In the second embodiment, valves 114, 125 having just an on-off operation, instead of the shut-off valves 15, 26 of the first embodiment, are provided at a pushing end 113 of the plasticizing pushing portion 110 and an injecting end 124 (outlet) of the metering injecting portion 120. These valves 114, 125 function in the same way as the shut-off valves 15, 26, and when closing, ensures sealing in the nozzle by preventing counterflow of the resin composite 4. The reinforcement fiber 3 may not be broken by these valves either. Other components are the same as those of the first embodiment, and their descriptions are omitted here.

According to the fiber filler reinforced resin injection molding apparatus 1A, the plasticizing pushing portion 110 includes a screw, not illustrated, in a cylinder 111, the resin 2 and reinforcement fiber 3 that are supplied from a hopper 112 are mixed and kneaded with the rotation of the screw for plasticizing (melting). Then, the plasticized resin composite 4 is supplied (pushed out) to the resin collection portion 130, and temporarily collected in the collector 131. The collected resin composite 4 is metered for the necessary amount for molding by the operation of the valve 133, and supplied to a junction portion 122 to the second injecting portion 120.

The metering injecting portion 120 has a piston, not illustrated, in a cylinder 121, and guides the resin composite 5, which has been plasticized at the plasticizing pushing portion 110 and temporarily collected in the collector 131 of the resin collection portion 130 to the junction portion 122, and makes the physical foaming agent 5 supplied from the SCF supply init 30 at the foaming-agent supply portion 123 be mixed with the resin composite 4. Then, after metering of the resin composite 4 for the necessary amount for molding, it injects the resin composite 4 into the cavity 43 of the mold 40 with a reciprocating movement of the injection piston. Herein, supplies of the resin composite 4 and the physical foaming agent 5 from the foaming-agent supply portion 123 at the junction portion 122 are controlled so as to be conducted almost at the same time. Thus, the supply of the physical foaming agent 5 to the resin composite 4 at the junction portion promotes the mixing and dispersion of the physical foaming agent 5 in the resin composite 4. Thus, the resin composite 4 with the sufficiently mixed physical foaming agent 5 is injected into the cavity 43 of the mold 40.

As described above, according to the second embodiment, the resin composite 4 containing the reinforcement fiber 3 is temporarily collected in the collector 130, and after the metering, the resin composite 4 is supplied to the metering injecting portion 120. At the metering injecting portion 120, the physical foaming agent 5 is supplied into the resin composite 4, and injected into the cavity 43 of the mold 40 via the metering injecting portion 120. Herein, the supply of the physical foaming agent 5 can further promote the mixing and dispersion of the physical foaming agent 5 in the resin composite 4. This function of promotion and effects by this function are the same as those of the first embodiment. Also, since the valves 114, 125 have the labyrinth structure, any breakage of the reinforcement fiber 3 can be avoided.

Further, the apparatus of the second embedment may have no needs for two injection units, the second embodiment has an advantage of low costs and less power-consumption, compared with the first embodiment.

### Embodiment 3

An entire structure of a fiber filler reinforced resin injection molding apparatus 1B according to a third embodiment of the present invention is shown in FIG. 10. The apparatus 1B is the same as the first embodiment in having two injection units, but different from that in injecting the resin composite 4 and others from the two injection units into the mold 40 directly at the same time.

A first injecting portion 210 (plasticizing-kneading portion) of the third embodiment includes a screw, not illustrated, which is preferable against the fiber breakage, in a cylinder 211, and the resin 2 to which lots of the reinforcement fiber 3 are added is supplied from a hopper 212 and then plasticized and kneaded. Then, after metering of the resin composite 4 for a necessary amount for molding, the resin composite 4 is injected into the mold 40 directly. Herein, the above resin 2 to which lots of reinforcement fiber 3 are added means that the resin 2 contains much more content of reinforcement fiber 3 than that of the fiber filler reinforcement resin molded article as a product. Then, a dilute resin 6, which will be described below, is mixed with this resin 2, so that the content of reinforcement fiber 3 can be maintained to a specified (desired) content of the fiber of the final product (fiber filler reinforcement resin molded article). The screw that is preferable against the fiber breakage is the one that suppresses breakage of reinforcement fiber 3 from being broken badly because of its proper screw shape or the like. Also, there are not provided any things, like the anti counterflow, that might cause breakage of the reinforcement fiber 3 at the first injecting portion 210. At an injecting end 213 (outlet) of the portion 210 are provided a shut-off nozzle 214a like the first embodiment or a valve 214b like the second embodiment. These are operated to open or close with their on-off operation, so the resin composite 4 is injected into the mold 40 without any breakage of the reinforcement fiber 3.

A second injecting portion 220 (metering injecting portion) includes a screw having a gas anti counterflow function, not illustrated, in a cylinder 221. The dilute resin 6 is supplied from a hopper 222, and the physical foaming agent 5 is supplied from the SCF supply unit 30. Thus, the dilute resin 6 is plasticized. Then, after metering of the dilute resin 6 containing the physical foaming agent 5 for a necessary amount for molding, the dilute resin 6 is injected into the mold 40 directly. Herein, the second injecting portion 220 comprises the screw with the gas anti counterflow function, and a foaming-agent supply portion 223 is disposed downstream of the hopper 222 (dilute-resin inlet), so the physical foaming agent 5 supplied from the foaming-agent supply portion 223 can be prevented from moving back upstream, and thereby the agent 5 and the dilute resin 6 can be prevented from leaking out from the hopper 222 properly. Also, since the reinforcement fiber 3 is not mixed with the dilute resin in the second injecting portion 220, any breakage of the reinforcement fiber 3 may not be caused. At an injecting end 224 (outlet) are provided a shut-off nozzle 225a or a valve 225b, and by their on-off operation for opening and closing, the dilute resin 6 is injected into the mold 40.

Herein, it is preferable that a viscosity of the resin composite 4 containing the reinforcement fiber 3 is substantially equal to a viscosity of the dilute resin 6 to which the physical foaming agent 5 has been supplied. Accordingly, since the difference in the viscosity between the resin composite 4 and the dilute resin 6 is small, the breakage of the reinforcement fiber 3 can be suppressed and the smooth mixing of the both can be attained. Namely, if the viscosity of the dilute resin 6 is improperly high, the reinforcement fiber 3 would receive a larger stress at the time of mixing, and thereby the risk of breakage of the reinforcement fiber 3 would increase. Accordingly, it is preferable that the dilute resin 6 have a properly low viscosity so that the larger stress can be prevented from acting on the reinforcement fiber 3.

And, since the resin composite 4 and the dilute resin 6 are injected into the mold 40 at the same time, the both substance 4, 6 join together in the path before the cavity 43 of the mold 40, thereby promoting the mixing and dispersion of the physical foaming agent 5 in the resin composite 4. Also, the physical foaming agent 5 is properly mixed in the cavity 43 of the mold 40, and the resin composite 4 in which the reinforcement fiber 3 with the specified content is dispersed uniformly is injected. Namely, the joining (confluence) of the both substance 4, 6 in the mold 40 functions as a mixing promoting means. Thus, the resin molded article having a desirable foaming ratio and excellent properties, such as strength, rigidity and the like, can be provided.

The above-described embodiments are just examples, and the present invention should not be limited to these. Any modifications can be applied within the scope of a sprit of the present invention.

Hereinafter, some modifications of the above-described embodiments by changing partially or adding something will be described.

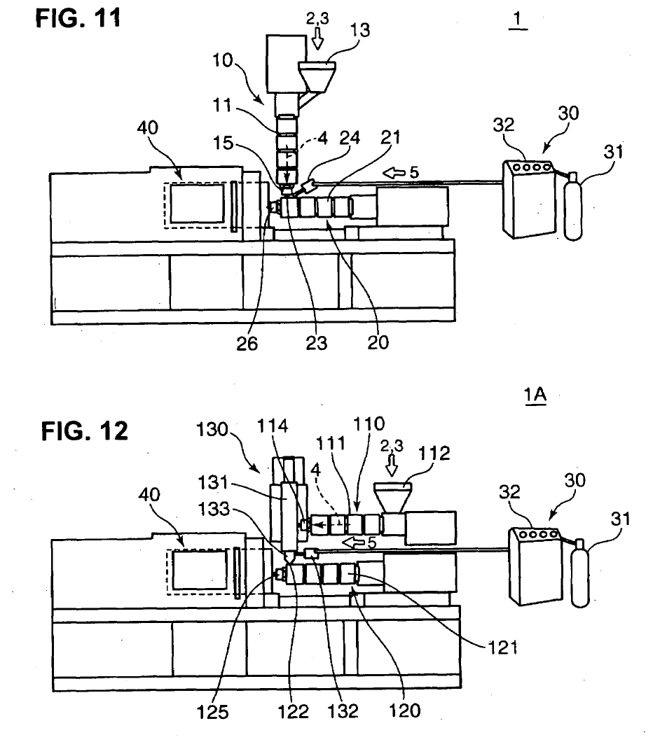

1) Although the physical foaming agent 5 is supplied at the second injecting portion 20 (foaming-agent supply portion 24) located upstream of the junction portion 23 and the mixing and dispersion of the resin composite 4 with the physical foaming agent 5 and the reinforcement fiber 3 is promoted at the junction portion 23 in the first embodiment, the supply portion of the physical foaming agent 5 may be located near the junction portion 23 (see FIG. 11). In this case, the physical foaming agent 5 is supplied at the same time as the confluence, so the mixing effect by the confluence can promote the mixing and dispersion of the physical foaming agent 5 in the resin composite 4.

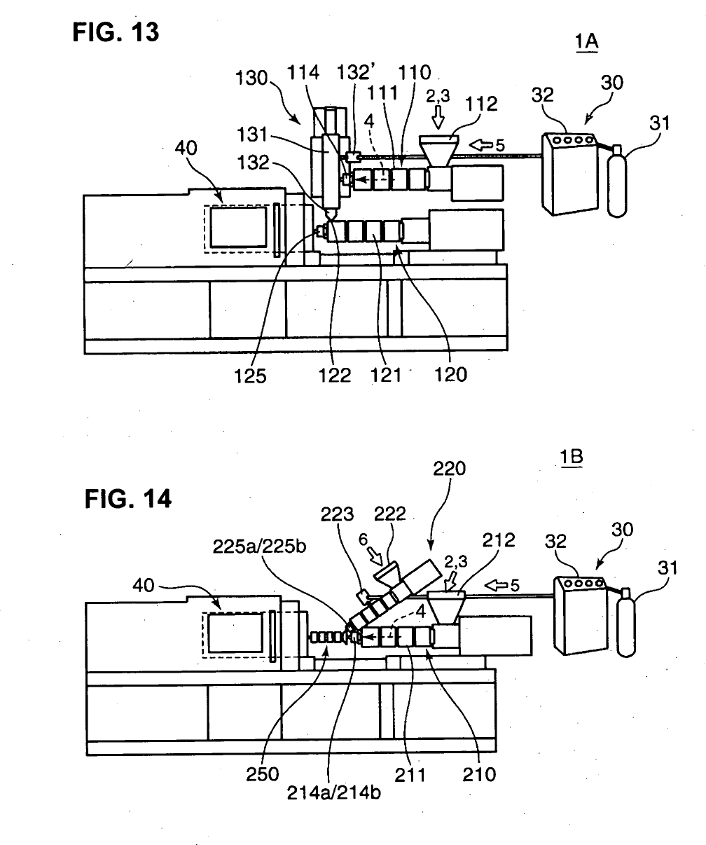

2) In the second embodiment, the physical foaming agent 5 is supplied at the metering injecting portion 120 (foaming-agent supply portion 123) beside the junction portion 122 where the resin composite 4 (molten resin) that has been collected temporarily in the collector 130 is supplied. However, the supply portion of the physical foaming agent 5 may be located downstream (specifically, just upstream of the valve 133) (see FIG. 12, foaming-agent supply portion 132) or upstream (see FIG. 13, foaming-agent supply portion 132′) of the supply portion of the resin composite 4 from the plasticizing pushing portion 110 as the resin collection portion 130. In this case, the mixing and dispersion of the physical foaming agent 5 in the resin composite 4 is promoted at the junction portion 122 as properly.

3) Although the mixing nozzle 50 is provided in the fist embodiment, the provision of the mixing nozzle should not be limited to the apparatus of the first embodiment. For example, in the above-described modification 1) of the first embodiment, the mixing nozzle may be disposed downstream of the junction portion 23 to promote the mixing and dispersion, and the resin composite 4 may be injected into the cavity 43 of the mold 40.

Also, in the modification 2) of the second embodiment, the mixing nozzle having the same attaching manners (A-C) disclosed in the first embodiment may be provided for the promotion of the mixing and dispersion of the physical foaming-agent 5, and then the resin composite 4 may be injected into the cavity 43 of the mold 40.

Further, in the third embodiment, the two injecting portions 210, 220 are connected to the mold 40 directly, and both the resin composite 4 and the dilute resin 6 join together in the mold 40. However, the both injecting portions 210, 220 may be connected to the mixing nozzle 250, the resin composite 4 and the dilute resin 6 are kneaded for the mixing and dispersion of the physical foaming agent 5, and then injected into the mold 40 (see FIG. 14). In this case, the physical foaming agent 5 is dispersed more uniformly in the resin composite 4 by the mixing effect in the mixing nozzle 250.

4) Although the first embodiment discloses a manner in that the agitating plate 28 is provided in the cylinder 21 of the second injecting portion 20, the provision of the agitating plate 28 should not be limited to the manner disclosed in the first embodiment. For example, in the second embodiment or the modification 2) of the second embodiment, the agitating plate may be provided at the injection piston of the cylinder 121 of the metering injecting portion 120 for the promotion of the mixing and dispersion of the physical foaming-agent 5, and then the resin composite 4 may be injected into the cavity 43 of the mold 40.

Also, in the modification 2) of the second embodiment, the agitating plate may be provided at the resin supply mechanism in the collector 131 of the collection portion 130 for the promotion of the mixing and dispersion of the physical foaming-agent 5, and then the resin composite 4 may be supplied to the junction portion 122 of the metering injecting portion 120.

Further, any vibration adding means such as the supersonic vibrator may be applied instead of the agitating plate in these embodiments.

5) Although the first embodiment discloses a manner in that the mixing portion 47 having the mixing-kneading function like the mixing nozzle 50 is provided at the hot runner portion 46 of the mold 40, the same structure as this may be applied to any medication of the first embodiment, the second embodiment or its medication. Although the porous structure 24b is disposed at the inner wall face of the injection nozzle 24a at the foaming-agent supply portion 24 of the second injecting portion 20 to increase the contact area with the resin composite 4 in the first embodiment, the same structure as this may be applied to any medication of the first embodiment, the second embodiment or its medication.

6) Although the second injecting portion 20 includes the injection piston 22 therein and the resin composite 40 is injected into the cavity 43 of the mold 40 by the reciprocating movement of the injection piston 22 in the first embodiment, the second injecting portion 20 may include a screw instead of the injection piston 22.

7) The dispersion function of the physical foaming agent 5 in the resin composite 4 may be enhanced by any mixing-dispersion promoting means different from the above-described embodiments and modifications. The porous structure provided at the foaming-agent supply portion disclosed in the first embodiment can enhance the dispersion function of the physical foaming agent 5 in the resin composite 4 with a more simple and sure way, thereby providing the resin molded article with the excellent properties. This enhancement of the dispersion function of the physical foaming agent 5 in the resin composite 4 can be materialized by increasing the pressure acting on the resin composite 4 (the pressure applied by the injection piston 22) or by possibly lowering the resin temperature below the meting point (within a proper range for plasticizing). By adding or applying these ways or means, the mixing and dispersion of the physical foaming agent 5 in the resin composite 4 can be promoted with the simple and sure way. An independent use of any means of these may be also applicable.

What is claimed is:

1. A molding method of a fiber filler reinforced resin molded article, which includes a plasticizing-kneading step of plasticizing and kneading a reinforcement fiber and a resin in a material supply cylinder having a screw, and a metering-injecting step of supplying a physical foaming agent to the resin plasticized in the plasticizing-kneading step and injecting the resin into a cavity of a mold, after metering a necessary amount of the resin for molding, the molding method comprising:
a foaming-agent supplying step of supplying the physical foaming agent to the resin that has passed through at least one nozzle or valve after being plasticized in the plasticizing-kneading step; and
a mixing-dispersion promoting step of promoting a mixing and dispersion of the physical foaming agent in the resin in a resin flow path from a supply portion of the physical foaming agent to the cavity of the mold.

2. The molding method of a fiber filler reinforced resin molded article of claim 1, wherein the mixing-dispersion promoting step is a step of agitation utilizing a flow of the resin.

3. The molding method of a fiber filler reinforced resin molded article of claim 2, wherein the agitation by utilizing the flow of the resin is caused by a supply of the physical foaming agent in the resin in the metering-injecting step.

4. The molding method of a fiber filler reinforced resin molded article of claim 1, wherein the mixing-dispersion promoting step is a step of adding a vibration to the resin.

5. The molding method of a fiber filler reinforced resin molded article of claim 4, wherein the addition of the vibration is adding a supersonic-wave vibration or an electromagnetic-wave vibration.

6. The molding method of a fiber filler reinforced resin molded article of claim 1, wherein the mixing-dispersion promoting step is a step of a driven agitation with an agitating member being driven in the resin flow.

7. The molding method of a fiber filler reinforced resin molded article of claim 1, wherein the mixing-dispersion promoting step is a step that is conducted in the resin flow path in the mold before the resin flowing into the cavity.

8. The molding method of a fiber filler reinforced resin molded article of claim 7, wherein the mixing and dispersion of the physical foaming agent is promoted by injecting the plasticized resin with the reinforcement fiber into a dilute resin to which the physical foaming agent has been supplied in the resin flow path in the mold.

9. The molding method of a fiber filler reinforced resin molded article of claim 8, wherein a viscosity of the resin with the reinforcement fiber is substantially equal to a viscosity of the dilute resin to which the physical foaming agent has been supplied.

10. The molding method of a fiber filler reinforced resin molded article of claim 1, wherein the physical foaming agent is a super critical fluid.

11. A molding apparatus of a fiber filler reinforced resin molded article, which includes a mold having a cavity that a resin is injected therein, a plasticizing-kneading portion operative to plasticize and knead a reinforcement fiber and the resin in a material supply cylinder having a screw, and a metering-injecting portion operative to supply a physical foaming agent to the resin plasticized in the plasticizing-kneading portion and inject the resin into the cavity of the mold, after metering an necessary amount of the resin for molding, the molding apparatus comprising:
a foaming-agent supplying portion operative to supply the physical foaming agent to the resin that has passed through at least one nozzle or valve after being plasticized in the plasticizing-kneading portion; and
a mixing-dispersion promoting portion operative to promote a mixing and dispersion of the physical foaming agent in the resin in a resin flow path from a supply portion of the physical foaming agent to the cavity of the mold.

12. The molding apparatus of a fiber filler reinforced resin molded article of claim 11, wherein the mixing-dispersion promoting portion is a portion to provide an agitation that utilizes a flow of the resin.

13. The molding apparatus of a fiber filler reinforced resin molded article of claim 12, wherein the agitation utilizing the flow of the resin is caused by a supply of the physical foaming agent in the resin in the metering-injecting portion.

14. The molding apparatus of a fiber filler reinforced resin molded article of claim 11, wherein the mixing-dispersion promoting portion comprises a device operative to add a vibration to the resin.

15. The molding apparatus of a fiber filler reinforced resin molded article of claim 14, wherein the device adding the vibration is a supersonic-wave vibration adding device or an electromagnetic-wave vibration adding device.

16. The molding apparatus of a fiber filler reinforced resin molded article of claim 11, wherein the mixing-dispersion promoting portion comprises an agitating member being driven in the resin flow.

17. The molding apparatus of a fiber filler reinforced resin molded article of claim 11, wherein the mixing-dispersion promoting portion is provided in the resin flow path in the mold before the resin flowing into the cavity.

18. The molding apparatus of a fiber filler reinforced resin molded article of claim 17, wherein the promotion of mixing and dispersion of the physical foaming agent by the mixing-dispersion promoting portion is conducted by injecting the plasticized resin with the reinforcement fiber into a dilute resin to which the physical foaming agent has been supplied in the resin flow path in the mold.

19. The molding apparatus of a fiber filler-reinforced resin molded article of claim 17, wherein the plasticized resin with the reinforcement fiber is collected in a resin collection portion, and the collected resin is supplied to the mold through the metering-injecting portion.

20. The molding apparatus of a fiber filler reinforced resin molded article of claim 11, wherein the physical foaming agent is a super critical fluid.
